(19) United States
(12) Patent Application Publication
(10) Pub. No.: US 2024/0020164 A1
(43) Pub. Date: Jan. 18, 2024

(54) METHOD AND SYSTEM FOR CONVERTING WEB RESOURCES INTO APPLICATIONS FOR USER DEVICES

(71) Applicant: Aleksey Burlitskiy, Tyumen (RU)

(72) Inventor: Aleksey Burlitskiy, Tyumen (RU)

(21) Appl. No.: 18/036,898

(22) PCT Filed: Nov. 13, 2020
(86) PCT No.: PCT/RU2020/000604

§ 371 Date: May 15, 2023

(51) Int. Cl. G06F 9/50

(52) U.S. Cl. CPC G06F 9/5033

(57) ABSTRACT

This technical solution relates to the field of computer technology, in particular to the method and system for converting a web resource into an application for user devices. The proposed solution is implemented through a method of converting a web resource into an application for the user device, which is performed using a processor and contains the following steps:
obtaining an information about a web resource in the form of at least a URL;
processed using a software container received URL, inside which the rules for saving a web resource on the user device are applied in the form of an application;
converting the web resource with the specified rules for saving the application on the user device;
saving the web resource as an application on the user device.

### FIELD OF TECHNOLOGY

This technical solution relates to the field of computer technology, in particular to the method and system for converting a web resource into an application for user devices.

### PRIOR ART

Currently, the technology of progressive web applications (PWAs), which allows to “extend” a web resource into an application analog, is becoming more popular. Another commonly used technology is the Apache Cordova solution, which allows to create a hybrid application for each web resource.

The problem with the above-mentioned approaches is that for different devices, in particular, different versions of operating systems and browsers, the presentation of web resources requires different actions on the part of the developer, both on the web resource itself and when creating a hybrid, and the resulting hybrids look and function differently.

Another method is described in patent application US 20070277109 A1 (IBM, 29.11.2007), which reveals the principle of presenting an application on user end devices using a kind of packer (Wrapper), which provides analysis and transfer of program logic and interface rendering from an external web application to the user device interface, thereby forming a native application.

The disadvantage of this solution is the need to re-analyze and transfer the logic, distribute and reinstall the updated application with each change in the external web application and for each operating system.

A common disadvantage of these well-known solutions is that when transferring a web resource in the form of an application to a user device, the unique rules for saving a web resource for each device are not taken into account, based on the characteristics of its operating environment, which makes in necessary to create separate rules for saving and/or program containers for each type of user devices.

### SUMMARY

To solve the above-mentioned technical problems, we propose a method that provides effective conversion of web resources into applications on user devices.

The technical effect achieved by implementing the claimed solution is to increase the efficiency of converting a web resource into an application on user end devices, which is to ensure the correct way to save the web resource, while maintaining its full functionality and the rules for displaying it, based on the parameters of the target device.

The proposed solution is implemented through a method of converting a web resource into an application for the user device, which is performed using a processor and contains the following steps:
obtaining an information about a web resource in the form of at least a URL;
processed using a software container received URL, inside which the rules for saving a web resource on the user device are applied in the form of an application;
converting the web resource with the specified rules for saving the application on the user device;
saving the web resource as an application on the user device.

In one of the particular embodiments of the method, a web resource is checked for the possibility of saving on the user device using a container.

In another particular embodiment of the method, verification is carried out by comparing the data of the operating environment of the user device with the saving rules applicable to the said environment.

In another particular embodiment of the method, the saving rules are based at least on the operating system (OS) parameters and the web browser parameters of the user device.

In another particular embodiment of the method, the screen resolution of the user device is additionally taken into account.

In another particular embodiment of the method, a unified user profile of the software container and the web resource is additionally formed, and the unified profile contains at least the ID received from the web resource.

In another particular embodiment of the method, a unified profile contains unified data for end-to-end user authorization using a software container on an external web resource.

In another particular embodiment of the method, the container online status is checked additionally, and the availability of the choice of the interaction method with the container for external API calls of the web resource is determined.

In another particular embodiment of the method, external API calls are selected from PUSH notifications, or a request for the permission of PUSH notifications, or a request the fact that the application container was installed earlier, or a request for authorization data of a unified profile.

In another particular embodiment, a unified profile data authorization request is a biometric authentication, PIN code, or graphic code.

In another particular embodiment of the method, the information about the web resource additionally contains a graphic icon or name.

The proposed solution is also implemented using a system for converting a web resource into an application for the user device, containing a processor and at least one memory facility, while the processor is designed with the ability to
receive information about a web resource in the form of at least a URL;

process the received URL using a software container, inside which the rules for saving a web resource on the user device are applied in the form of an application
convert a web resource with the specified rules for saving the application on the user device;
save a web resource as an application on the user device.

In one of the particular implementations of the system, a web resource is checked for the possibility of saving on the user device using a container.

In another particular embodiment of the system, verification is carried out by comparing the data of the operating environment of the user device with the saving rules applicable to the said environment.

In another particular embodiment of the system, the saving rules are based at least on the (OS) parameters and the web browser parameters of the user device.

In another particular embodiment of the system, the screen resolution of the user device is additionally taken into account.

### BRIEF DESCRIPTION OF DRAWINGS

FIGS. 1A-1B illustrate an example of saving a web resource using a container.

FIG. 2 illustrates an example of filling a container.

FIG. 3 illustrates an example of manually saving a web resource using the administrator panel.

FIG. 4 illustrates the flowchart of the proposed method.

FIG. 5 illustrates the general scheme of the computing device.

### DETAILED DESCRIPTION OF THE INVENTION

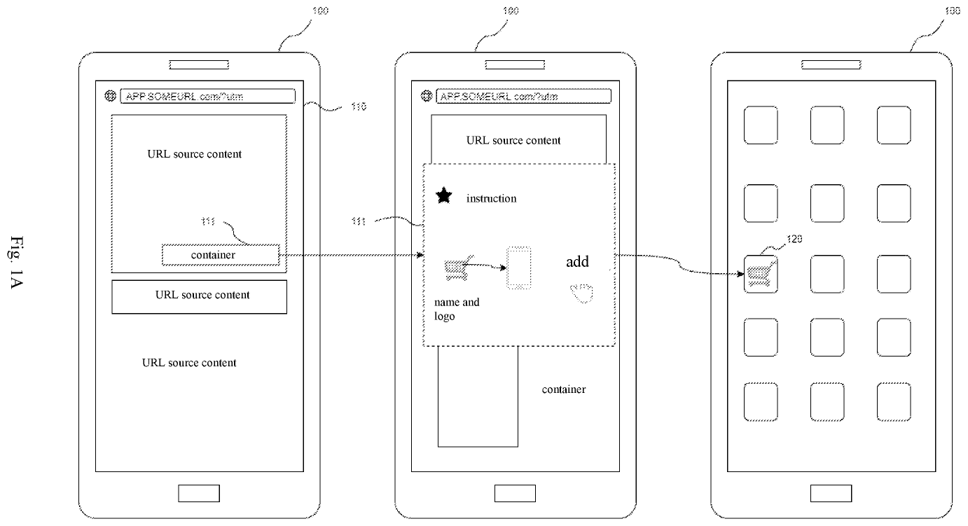

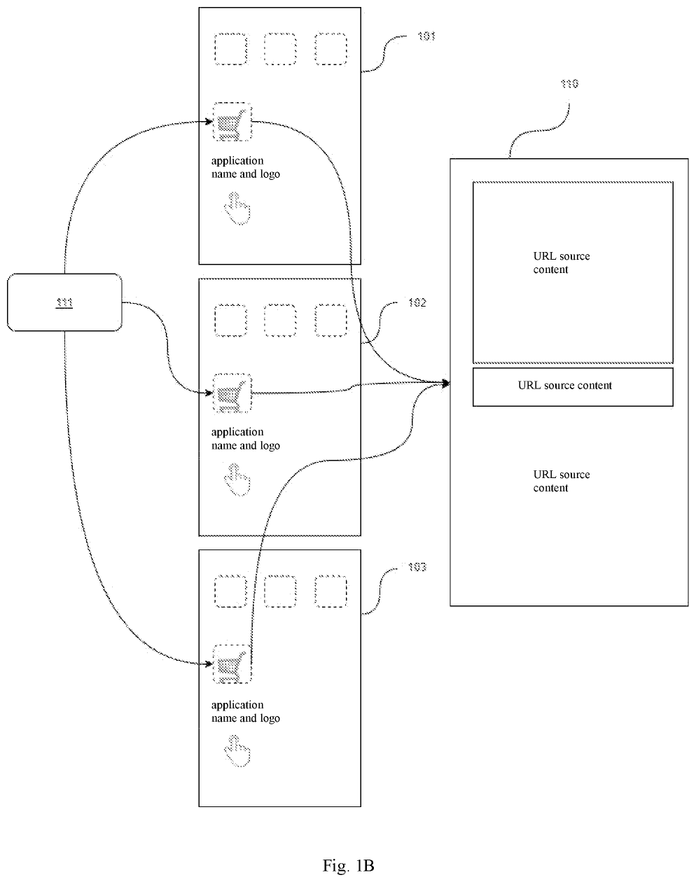

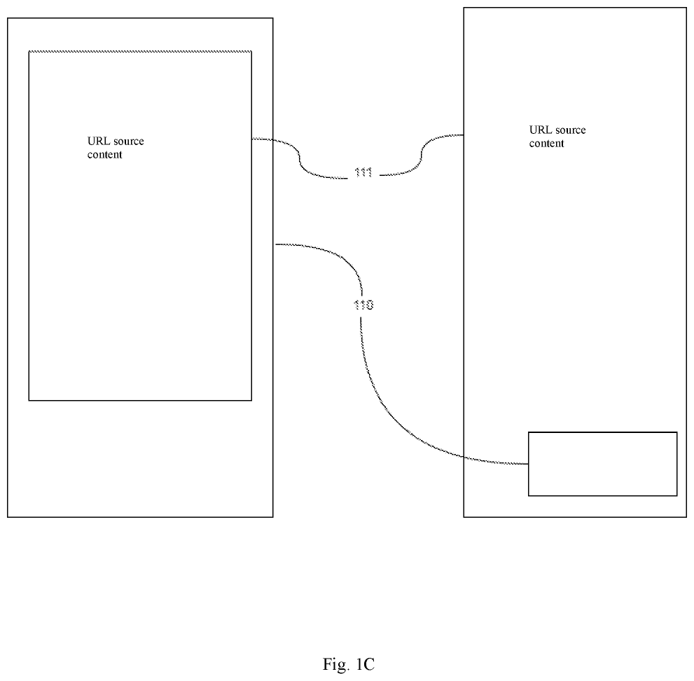

As shown in FIG. 1A-1B, the claimed technical solution allows you to convert an external web resource (110) displayed in the browser of the user device (100), for example, a smartphone, tablet or personal computer, into an installable application (120). The conversion of a web resource (110) is carried out by using a software container (111) hosted on a web resource (110). Container (111) can be both an external shell for a web resource (110) (iframe) and an installable extension (using Java Script libraries to obtain installation functions), this example is illustrated in FIG. 1B, which shows an example with a shell on the left; on the right is the implementation of the container (111) in the form of an extension.

This technology greatly simplifies the process of creating and delivering network applications of any kind to the user and does not depend on the source or method of production, such as CMS systems (for example WordPress, Wix, Shopify, BigCommerce, Bitrix, etc.), frameworks or programming languages (for example VUE, Angular, JS, etc.) or databases (for example, My SQL, PostgreSQL, MS SQL, MongoDB, etc.) The technology also simplifies the above-mentioned process regardless of the user agent or viewing method by type of device (for example, smartphone, PC etc.) or operating environment (a combination of operating system and browser).

The process of converting a web resource (110) is carried out directly on the user device (100) by activating the container logic (111), which receives information about the web resource (110), in particular its URL, but also available information about the name of the web resource and the presence of a graphic icon can be used, which can also be used during conversion.

The container (111) connects to the web resource saving rule base (110) for the user device (100). This database takes into account many variations of the rules for saving web resources (110), based on the characteristics of various target devices, as shown in FIG. 1B for different examples of saving on devices (101)-(103). The conversion of the web resource (110) is carried out according to the specified rules suitable for the specific device (100) from which such a request is received and the activation of the container (111) is performed, during which the logic of the installed application (120) is formed on the device containing all the functions and display parameters of the web resource (110).

The proposed method takes into account the rules for creating and saving applications in various conditions and modifies its behavior for each individual user device (101)-(103), depending on the current conditions of the receiving device (agent), taking the saving rules to a higher level from the content and application logic itself, and routing the rules depending on the environment of their execution. Thus, the content source does not require any modifications, but works inside the system container (111), providing processes for saving applications (120) and accessing them in each individual user operating environment on the selected device (100).

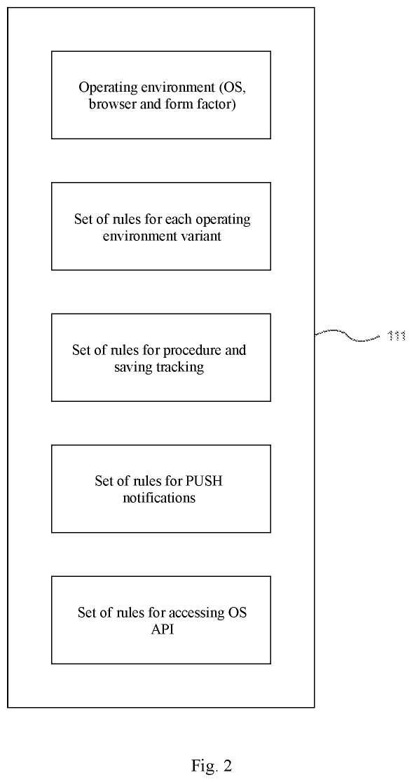

FIG. 2 shows an example of filling the container (111). The container (111) stores application-level methods and data, while also storing inside (or requesting from outside) a set of container-level rules for automatic adaptation, depending on a combination of parameters such as operating system (OS), browser, and operating environment form factor. Container (111) uses any of the available technologies in which the content source is external (iframe, portals) when using an internal container. The container has external outputs for interacting with the resource's backend systems via the API and makes it possible to call the specified API from an external source.

Under the application-level data used in the container (111), the manifest of the web resource (110) can be used, which includes a set of following data: the icon displayed after saving, principle of loading the web resource (110) (with or without the address bar or in full-screen mode), screen saver (Splash screen), color theme, screen orientation, initial url, etc. As a rule, the manifest is a JSON file.

Also, another important piece of data used in the container (111) is the service worker, acting as a proxy server located between the web application (110) and the device browser (100), and the network, if it is available. The service worker describes the correct behavior of the web application (110) in offline mode, provides interception of network requests and takes appropriate measures based on network availability. Also, it allows you to update the data on the server when accessing it, and has access to PUSH notifications and API for background synchronization.

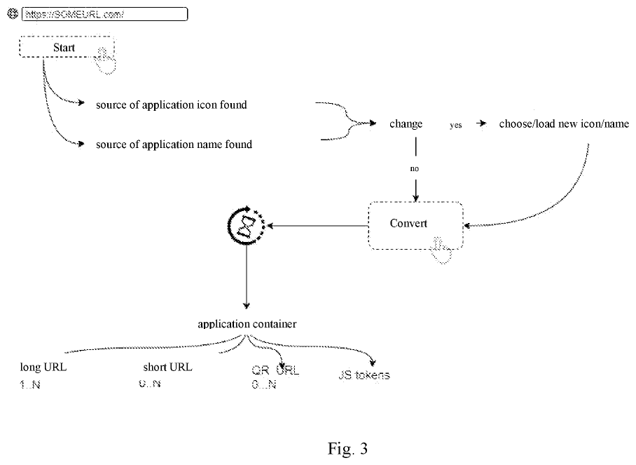

Container filling (111) can be carried out automatically or manually. Automatic filling uses the available data from the web resource (110) to fill all the rules of the container (111), for example, a graphical component (e. g. favicon to create all the necessary permissions for the application icon) and the application name. This information can be obtained by parsing the content of the web resource (110). With manual filling, all the data necessary according to the rules of operation of the container (111) are filled in the administrator panel, shown in FIG. 3. Alter filling with data, the container (111) is created, and as a result of this process, UM., links to the container (111) and/or tokens are generated to receive the container (111) from the server online.

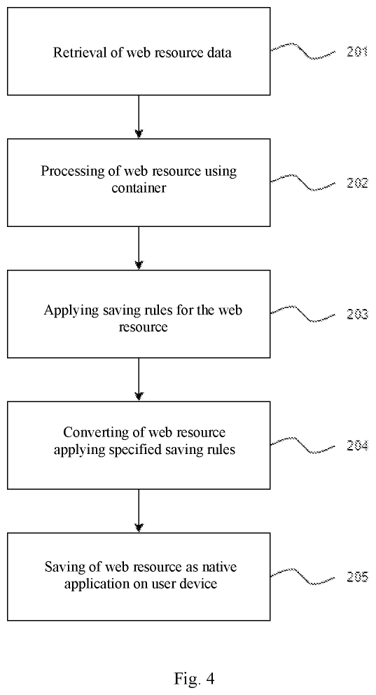

FIG. 4 shows a block diagram of the implementation of the proposed method. At the first stage (201), the user logs in to a web resource (110) that includes a container (111) using the web browser of the device (100). When the container (111) is activated, the URL of the corresponding web resource (110) is processed. When the container (202) is activated, the user device operating environment options (100) are checked, for which the container (111) accesses the storage of environment options. Checking the operating environment options includes analyzing which operating environment and which browser the container (111) is open on, including checking WebView, checking whether it is possible to save the application in a direct way in this operating environment, and which method is suitable for this operating environment.

The storage of environment variants is a logical tree that can either be part of the program code of the container itself (111), that is, in the memory of the device (100) from which the input is made, or be located on an external source to which the request is made in real time and a certain saving rule is returned. The proposed solution implements a hybrid approach in which the rules are already present in the container (111), but at the same time, when saving the web resource (110), it is checked that the mentioned rules are up-to-date and the container (111) includes their latest version.

At stage (203), after processing the data of the operating environment of the device (100), the web resource (110) is saved using the saving rules applied by the container (111). At this stage, the logic of the container (111) also accesses the storage of auxiliary methods/instructions to ensure the process of saving the web resource (110).

The saving rules take into account the features of the target device (100) and form the correct type of the web resource (110) display in the user interface, based on the OS and browser installed on the device (100), as well as screen resolution, aspect ratio, etc.

At stage (204), the conversion of the web resource (110) is performed, taking into account the rules for saving the container (111) and the formation of a native application (120) in the operating environment of the device (100) at stage (205).

At stage (204), the method of interaction of the container (111) with the operating environment of the device (100) can additionally be selected, for which the logic of the container (111) accesses the repository of notification rules for each variant of the operating environment for a similar type of device, as well as a set of rules for accessing the API of the operating system of each mentioned operating system. Depending on the operating environment, the container (111) displays only those methods that are possible in this environment, for example, if the web resource (110) generates a request for the possibility of sending PUSH notifications, then the container (111) analyzes the available methods for this type of notification.

At stage (205), data about the user's choice can additionally be saved, for example, the fact of installing the container (111); whether PUSH notifications are permitted; in which operating environment the saving was performed; and whether there is a unified profile.

When converting a web resource (110), it can also be checked whether the container (111) is online and whether the interaction method with the container (111) is available for external API calls of the web resource (110). External API calls can imply PUSH notifications, or a request to allow PUSH notifications, or a request about prior container installation, or a request for authorization data for a unified profile, etc. The above mentioned verification can be carried out by means of hierarchical interaction methods of the PARENT-CHILD type, using standard POST messages for those types of operations where there is a handler for such messages, and by sending a label that the input is now done through the application and the site can use the corresponding methods in this case. The label is sent to the web resource (110) by the container (111).

For each user who activates the container (111) to save the web resource (110), the user's authorization data can be checked and a new user profile can be created, if previously information about such a user was not stored in the system associated with the container (111) and including information about registered unified user profiles. A unified profile can contain the following information about users: user IDs, information about installed applications, facts of linking PUSH message channels, facts of installing authorization tokens, user data from a web resource, and IDs of web resources.

The unified profile contains unified data for end-to-end user authorization using a software container (111) on an external web resource (110).

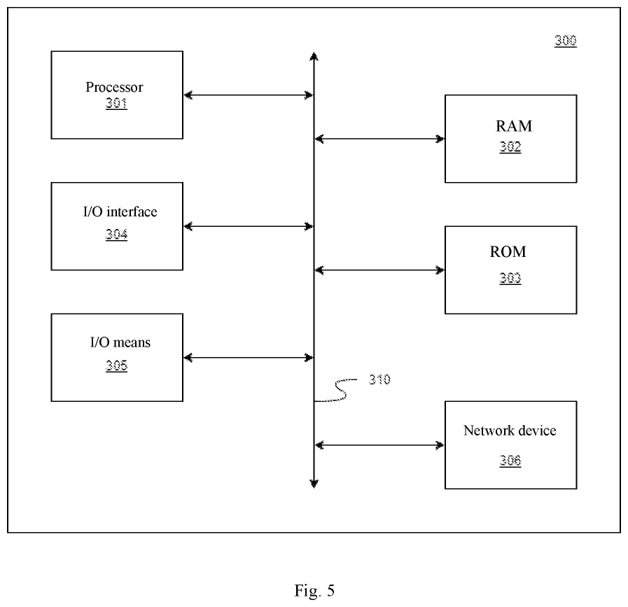

FIG. 5 shows a general example of a computing system based on a computing device (300), for example, a computer, server, laptop, smartphone, etc., which can be used for the full or partial embodiment of the proposed solution and the devices used in it. In general, the device (300) contains components such as: one or more processors (301), at least one RAM (302), a permanent data storage means (303), I/O interfaces (304), I/O means (305), and networking device (306).

The processor (301) of the device performs the basic computing operations necessary for the functioning of the device (300) or one or more of its components. The processor (301) executes the necessary machine-readable commands contained in the RAM (302).

Memory (302), as a rule, is embodied as RAM and contains the necessary software providing the required functionality. The data storage means (303) can be embodied as HDD, SSD disks, raid array, network storage, flash memory, optical information drives (CD, DVD, MD, Blue-Ray disks), etc. The data storage means (303) allows long-term storage of various types of information, for example, request processing history (logs), user IDs, camera data, images, etc.

Interfaces (304) are standard means for connecting and working with various devices. Interfaces (304) can be, for example, USB, RS232, RJ45, LPT, COM, HDMI, PS/2, Lightning, FireWire, etc. The choice of interfaces (304) depends on the specific design of the device (300), which can be a personal computer, mainframe, server cluster, thin client, smartphone, laptop, etc., and connected third-party devices.

As a means for I/O (305) the following devices can be used: keyboard, joystick, display (touch display), projector, touchpad, mouse manipulator, trackball, light pen, speakers, microphone, etc.

The means of network interaction (306) are selected from a device that provides network reception and data transmission, for example, an Ethernet card, a WLAN/Wi-Fi module, a Bluetooth module, a BLE module, an NFC module, an IrDA, an RFID module, a GSM modem, etc. Using the means (306), the organization of data exchange over a wired or wireless data transmission channel is provided, for example, WAN, PAN, LAN (LAN), Intranet, Internet, WLAN, WMAN or GSM, quantum data transmission channel, satellite communication, etc.

The components of the device (300) are usually interfaced via a common data bus (310).

In these application materials, the preferred embodiment of the proposed technical solution was presented, which should not be used as limiting other, private embodiments of its implementation, which do not go beyond the requested scope of legal protection and are obvious to specialists in the relevant field of technology.

1. A method of converting a web resource into an application for a user device, performed using a processor and containing the following steps:
obtaining an information about a web resource in the form of at least a URL;
processed using a software container received URL, inside which the rules for saving a web resource on the user device are applied in the form of an application;
converting the web resource with the specified rules for saving the application on the user device;
saving the web resource as an application on the user device.

2. The method according to claim 1, wherein the web resource is checked for the possibility of being saved on the user device using a container.

3. The method according to claim 2, wherein the verification is carried out by comparing the data of the operating environment of the user device with the saving rules applicable to the environment.

4. The method according to claim 3, wherein the saving rules are based at least on the OS parameters and parameters of the user device web browser.

5. The method according to claim 4, wherein additionally takes into account the screen resolution of the user device.

6. The method according to claim 1, wherein a unified profile of the software container and the web resource user is additionally formed, and the unified profile contains at least the web resource ID.

7. The method according to claim 6, wherein a unified profile contains unified data for end-to-end user authorization using a software container on an external web resource.

8. The method according to claim 1, wherein the container online status is checked additionally, and the availability of the choice of the interaction method with the container for external API calls of the web resource is determined.

9. The method according to claim 8, wherein external API calls are selected from PUSH notifications, or a request for the permission of PUSH notifications, or a request the fact that the application container was installed earlier, or a request for authorization data of a unified profile.

10. The method according to claim 1, wherein the information about the web resource additionally contains a graphic icon or name.

11. A system for converting a web resource into an application for a user device, containing a processor and at least one memory, wherein the processor configured to:
receive information about a web resource in the form of at least a URL;
process the received URL using a software container, inside which the rules for saving a web resource on the user device are applied in the form of an application;
convert a web resource with the specified rules for saving the application on the user device;
save a web resource as an application on the user device.

12. The system according to claim 11, wherein the web resource is checked for the possibility of being saved on the user device using a container.

13. The system according to claim 12, wherein the verification is carried out by comparing the data of the operating environment of the user device with the saving rules applicable to the environment.

14. The system according to claim 13, wherein the saving rules are based at least on the OS parameters and parameters of the user device web browser.

15. The system according to claim 14, wherein additionally takes into account the screen resolution of the user device.
